(19) United States
(12) Patent Application Publication
(10) Pub. No.: US 2004/0148566 A1
(43) Pub. Date: Jul. 29, 2004

(54) Method to evaluate project viability

(75) Inventors: Mustafa X. Jaffar, London (GB); Julian H. Cork, London (GB)

Correspondence Address: GLEN E. BOOKS, ESQ., LOWENSTEIN SANDLER PC, 65 LIVINGSTON AVENUE, ROSELAND, NJ, 07068, US

(73) Assignee: JP MORGAN CHASE BANK

(21) Appl. No.: 10/437,368

(22) Filed: May 13, 2003

Related U.S. Application Data
(60) Provisional application No. 60/442,500, filed on Jan. 24, 2003.

(51) Int. Cl. G06F 17/21

(52) U.S. Cl. 715/503

(57) ABSTRACT

A method of rating a project provides a functional result in the form of a standardized rating of project viability. The method receives data regarding a project and uses that data to generate the standardized rating, and costs and benefits of project, including the dollar benefits, the non-dollar benefits. For each project, a symbol of varying size representing a project parameter, such as total cost of the project, can be plotted on at least two axis, one axis representing a dollar benefit score, and the other axis representing a non-dollar benefit score. Those using the results generated by the method can then take appropriate actions regarding one or more projects. The method's evaluation results are useful for project pre-planning, approval, and evaluation of the project's viability as it progresses towards completion. It can also be used for a full post-implementation review to confirm whether the project's targets have been met.

### CROSS REFERENCE TO RELATED APPLICATIONS

This utility application “A Method to Evaluate Project Viability” claims priority from U.S. Provisional Application S/No. 60/442,500, “A Method to Evaluate Project Viability”, filed Jan. 24, 2003. The 60/442,500 application is incorporated by reference herein.

### FIELD OF THE INVENTION

This invention relates to a method for evaluating a project's viability, and in particular, to an evaluating method that provides a standardized representation of a project's viability based on return on investment.

### BACKGROUND OF THE INVENTION

“Projects” are human endeavors that incur costs to achieve results. The costs can include dollar costs for required supplies, manpower costs, and overhead expenses (such as building leases). The potential benefits of the project provide the motivation to accept the costs. Benefits can be “hard” dollar benefits, such as reduced expenses or increased profit. Benefits can also be “soft” non-dollar benefits such as upgrading a software application to comply with a new industry-wide standard. Other examples of soft benefits are a change in a company's business direction, such as aligning a corporate activity with a company's policy or vision.

Thus, there is a need to evaluate projects for likelihood of success and return on investment (ROI). ROI is proportional to the profit or loss attributable to a project over various periods of time. It is usually expressed as a percentage of return for a given investment in a project. ROI calculations typically account for the net present value of money (NPV).

The need for evaluation applies to all sizes of projects and all sizes of organizations from small one-person companies to large corporations. In the past, various strategies for project evaluation have been presented. Most have been specifically tailored to the type and size of the projects. Past methods have required long lists of complex input parameters. Also, existing methods are typically tailored to a specific line of business (LOB). Finally, the evaluation results have been presented in widely varying formats, styles, and levels of detail.

Therefore, there is a need for a method for evaluating projects that provides a standardized representation of the project's viability. More specifically, there is a need for a method that is applicable across various working groups and LOBs. That is, the method's results should be standardized to allow easy comparison between projects without additional consideration as to the size of the project, what area of a company the project originated in, or what LOB it pertains to. Furthermore, there is a need for simple data entry (i.e., a relatively small number of required input parameters) to generate a standard project rating.

### SUMMARY OF THE INVENTION

A method of rating a project provides a functional result in the form of a standardized rating of project viability. The method receives data regarding a project and uses that data to generate the standardized rating, and costs and benefits of project, including the dollar benefits, the non-dollar benefits. For each project, a symbol of varying size representing a project parameter, such as total cost of the project, can be plotted on at least two axis, one axis representing a dollar benefit score, and the other axis representing a non-dollar benefit score. Those using the results generated by the method can then take appropriate actions regarding one or more projects. The method's evaluation results are useful for project pre-planning, approval, and evaluation of the project's viability as it progresses towards completion. It can also be used for a full post-implementation review to confirm whether the project's targets have been met.

### BRIEF DESCRIPTION OF THE DRAWINGS

The advantages, nature and various additional features of the invention will appear more fully upon consideration of the illustrative embodiments now to be described in detail, taken in connection with the accompanying drawings. In the drawings:

FIG. 1 is a simplified block diagram of a computer system showing a server and a client for running computer software to accomplish project evaluation according to the inventive method;

FIG. 2 is a simplified block diagram of the method as implemented in one embodiment called the “Complete Investment Model” (CID);

FIG. 3 is a sample of a first worksheet of the CID before the user has entered any data into the user input fields;

FIG. 4 is a sample of the summary view of a second worksheet of the CID before the user has entered any data into the user input fields;

FIGS. 5 and 5A are a sample of the data input view of the second worksheet of the CID before the user has entered any data into the user input fields;

FIG. 6 shows a breakdown of the dollar benefits score;

FIG. 7 is a sample of a third worksheet for data input of the non-dollar benefits of the CID before the user has entered any data into the user input fields;

FIG. 8 is a sample project summary for a fictitious project;

FIG. 9 shows the correlation between the project rating and project score according to one embodiment of the inventive method;

FIG. 10 shows a screen print of an exemplary LOTUS Notes database entry form;

FIG. 11 shows a screen print of a completed entry form;

FIG. 12 shows a screen print of the project method's functional results sorted by budget year;

FIG. 13 shows a screen print of the project method's functional results sorted by project sponsor; and

FIG. 14 shows a screen print of the project method's functional results sorted by the data field “CTO.”

FIG. 15 is a screen print of the project summary for a hypothetical ongoing computer trading project involving 50,000 trades per day;

FIG. 16 is a screen print of the project summary for the hypothetical project of FIG. 10 that has experienced a 50% increase in some costs and a fall in the number of trades to 30,000 per day;

FIG. 17 is a sample of worksheet 1 of the project summary for the hypothetical project of FIG. 10 where the number of trades is still 30,000 per day, but other adjustments have been made to increase the viability of the project;

It is to be understood that the drawings are for the purpose of illustrating the concepts of the invention, and, except for the graphs, are not to scale. It is also understood that all application code, other framework code, database programs, and data reside on computer readable media and run on one or more computer systems including standard computer components and operating systems as known in the art.

### DESCRIPTION

The application is divided into two parts. Part I introduces the method of evaluating projects and the form of the functional results. It does this in terms of one embodiment of the invention called the “Complete Investment Decision Model” (CID). Part II provides three exemplary scenarios and shows how the CID can be used to improve the viability of a hypothetical project.

Part I: A Method for Generating a Standard Rating of Project Viability based on Return of Investment

The inventive method is explained in terms of an embodiment called the Complete Investment Model (CID). This exemplary embodiment is implemented in Microsoft Excel, an industry standard spreadsheet program, with some graphical features and page selections additionally provided by code written in Microsoft Visual Basic. It is understood that the inventive method can also be implemented in most computer languages known in the art, including object oriented languages such as C++ and Java.

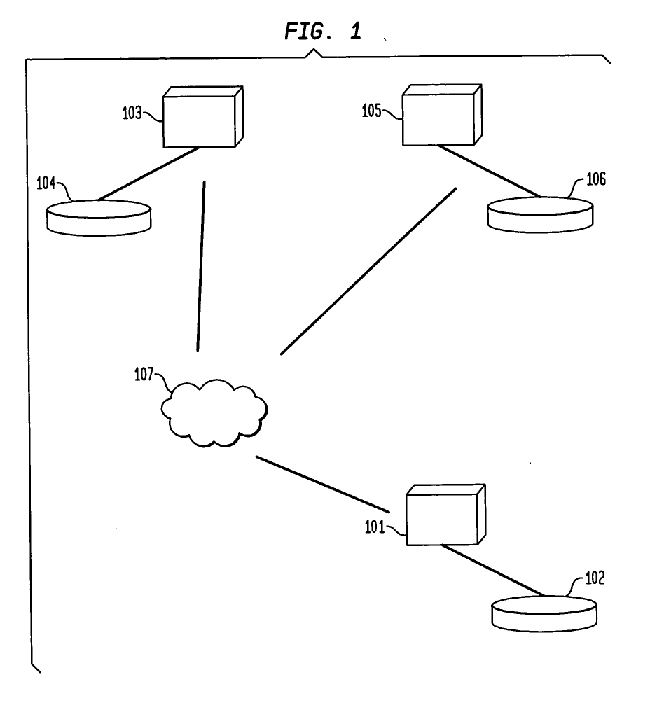

FIG. 1 shows computer server 103 on network 107, serving client 101. In one embodiment, client 101 can download the CID software from server 103 and run it on the client. Typically the CID software would be downloaded by a web browser running on client 101. Other file transfer methods can be used. Also, CID software can independently reside on client 101 and run outside of a network environment. In another embodiment, the CID software can run completely on the server 103, whereby client 101 functions only as an input/output (I/O) terminal. Results generated by the CID software can be save to memory (typically a hard-drive) 102 at the client terminal, 104 at the server, or 106 at a another client or server machine 105 on the network. The network 107 can be an intra-net, the Internet, or a combination of the two.

In this exemplary embodiment, there are three main worksheets. A worksheet comprises an array of cells where some cells are labels, some cells accept user inputs, and other cells perform calculations. In CID, cells are color-coded by cell type. Heading cells are colored green, user entry cells are colored brown, and automatically calculated cells are colored blue. For purposes of making this disclosure readily available for distribution in black and white, sections of color are indicated in some of the introductory example spread sheets. In some block diagrams, user entries are denoted by a “(u)” in the lower right hand corner, labels by “(l)”, and calculated blocks by “(c)”.

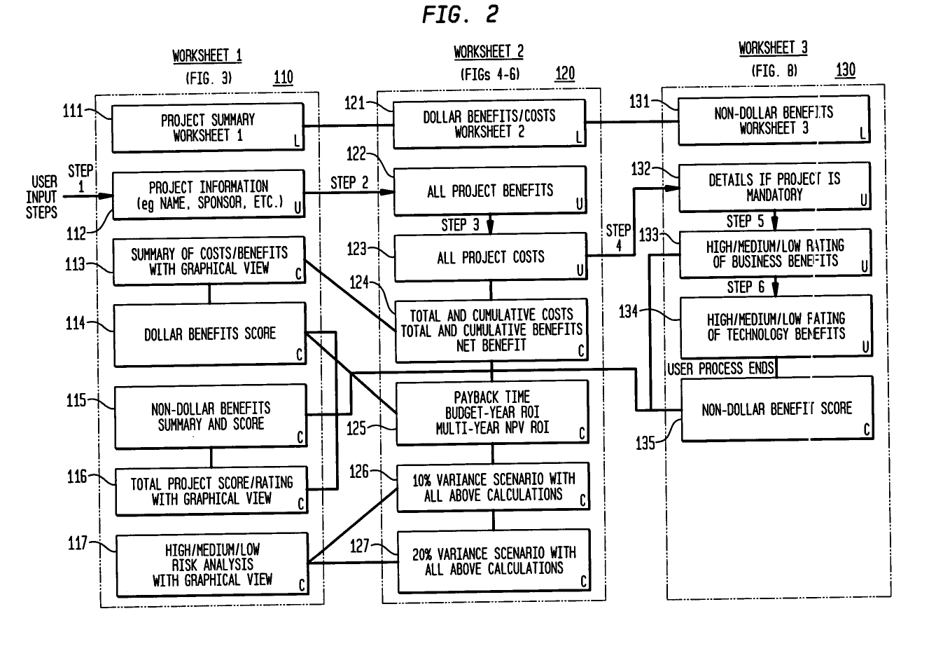

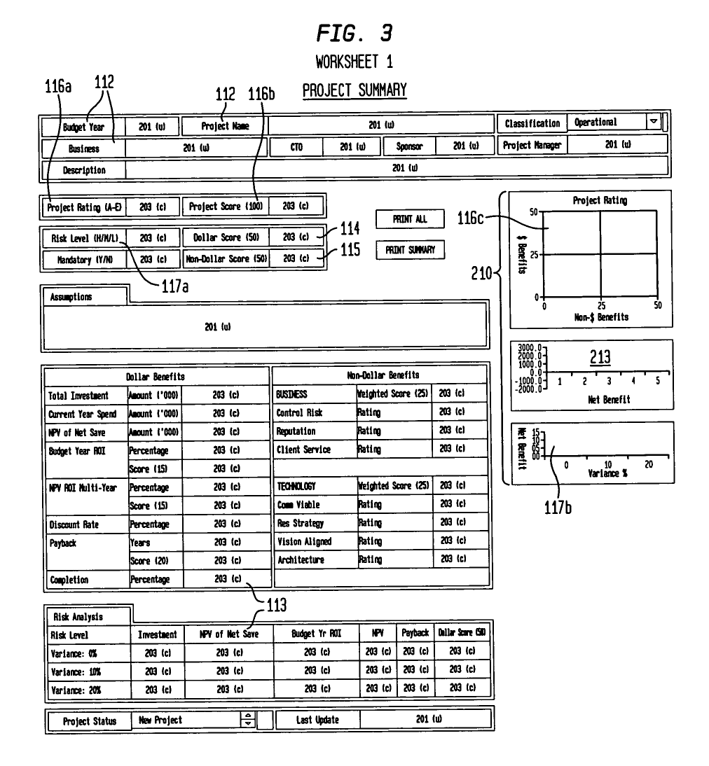

Turning now to FIG. 2, a block diagram of the relationship among all worksheets is shown. Worksheet 1 110 comprises label cell 111, user input cell 112 and calculation cells 113-117. Worksheet 2 120 comprises label cell 121, user input cells 122 and 123 and calculation cells 124-127. Worksheet 3 130 comprise label cell 131, user input cells 132-134 and calculation cell 135. Each page will be discussed further, below, in connection with FIGS. 3-6.

In general, the user enters data on each of Worksheet 1 110, Worksheet 2 120 and Worksheet 3 130 in a plurality of steps. On Worksheet 1 110, user information input, herein labeled “user information flow” and shown with single-header arrows, begins with step 1 arrow, which points to user input cell 112. The user enters project information, including, but not limited to, the name and sponsor of the project.

User input step 2 continues to Worksheet 2, wherein the user enters project benefits in user input cell 122. In User input step 3 the user enters project costs in user input all 123. Processing then moves to Worksheet 3 130, in step 4, wherein the user optionally enters details of the project in user input cell 132. In User input step 5, the user enters an estimated rating of business benefits in user input cell 133. Finally, in step 6, the user enters a rating of technology benefits in user input box 134. User entry ends at this point.

The solid lines connect calculating cells to user input cells and to each other. The calculating cells take data input from user input cells, perform calculations and generate a value. Each value may be displayed in a respective worksheet cell. Further, the value generated by a calculation cell may itself be used by another calculation cell.

By way of example, the user input in user input cell 123 is used by calculation by 124. Calculation cells 115, 125 and 135 use the value generated by calculation cell 124. The value generated by calculation cell 125 is used by calculation cell 126, etc. These relationships among cells are illustrated herein according to an exemplary embodiment of this invention and are thus not intended to be limiting. One skilled in the art will realize how to make and use this invention employing other cell relationships after studying this specification.

FIG. 3 shows a “screen print” (in black and white) of project summary worksheet 1 111 prior to any data entry. User project names and identifiers are entered in text in step 112 (FIG. 1) in user entry cells 201 on Worksheet 1 111. After the entry process is complete, calculated numerical results appear in calculated cell 203. These numerical results include the important standard project rating 205, the standard project score 116b, the dollar cost component score 114, and the non-dollar cost score 115. Further, these numerical results are also presented in graphical displays 210, including the important graphical project rating 116c. Year by year annual benefits, costs, net benefits, and cumulative benefits are graphically displayed in bar graph 213, and net benefits for 10% and 20% project overages are shown in graph 212 (corresponding to FIG. 2, worksheet 117b).

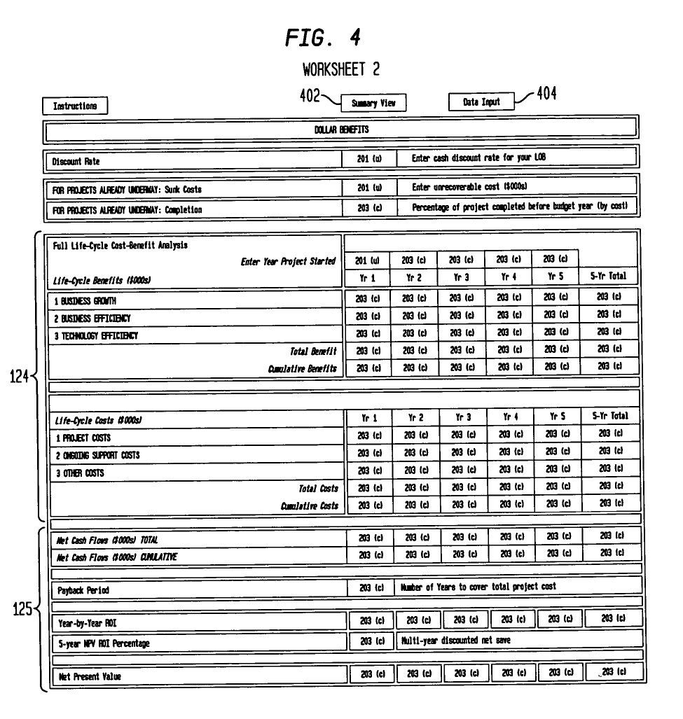

FIG. 4 shows a screen print of worksheet 2 120 before any user entries have been made. Calculation cells 203 show numerical values for dollar costs broken down by year. FIG. 4 is a “Summary View” of worksheet 2 120 as selected by button 402. The “Data Input” button 404 selects the user input page as shown in FIG. 4.

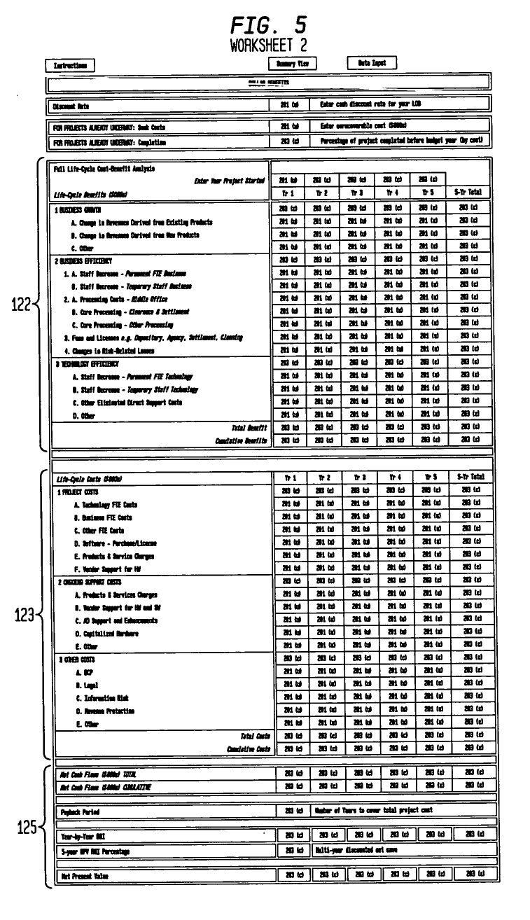

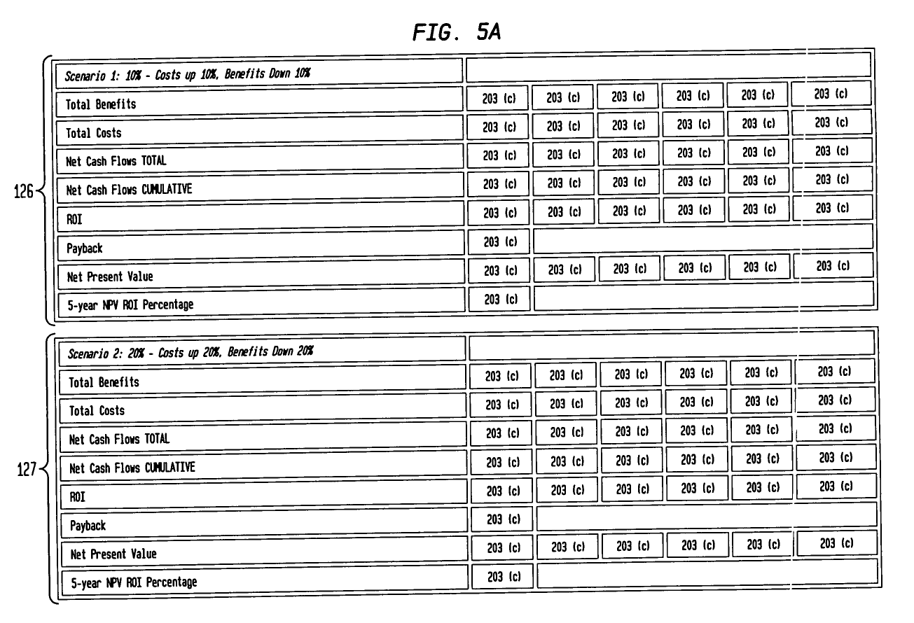

FIGS. 5 and 5A, show an unpopulated user input representation of worksheet 2 120. Input cells 201 allow the user to enter raw costs ranging from changes in revenues caused by the project, such as “life cycle benefits” 122, including staffing costs in business efficiency, technology efficiency including changes in staffing caused by the project, and life cycle costs 123, including project costs, support costs, and miscellaneous project costs. Calculated numerical ROI values for these user inputs appear towards the bottom of this page (FIG. 5) at 125.

ROI and (net present value) NPV time value of money financial calculations are standard calculations as know in the art. The model assumes a user entered discount rate for time value of money calculations. For example, if a dollar today is projected to be worth $1.12 at some defined period of time in the future, that corresponds to a discount rate of 12% for that time interval. The model factors in the discount rate by techniques known in the art. Sections 126 and 127 (FIG. 5A) display the calculated data for 10% and 20% cost overruns.

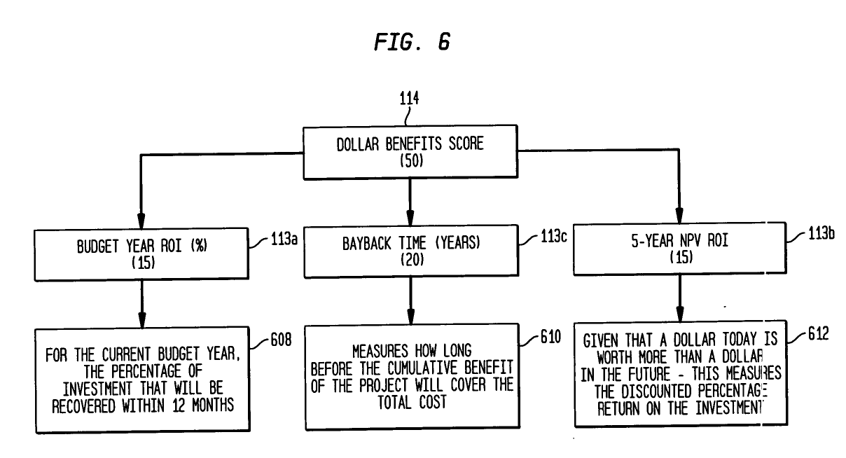

A final score of 1 to 50 is developed for the dollar benefits section based on standard ROI calculations. But, one inventive aspect of the method is that it factors in a weighted calculation for the budget year ROI, the multiyear ROI, and the total project payback. FIG. 6 further illustrates the meaning of these calculations. The three calculated dollar benefit values Budget Year ROI (%) 602 defined in box 608, Payback time 604 defined in box 610, and 5-Year NPV ROI 606 defined in box 612, are then combined and mapped to the 1 to 50 dollar benefit score 208 calculated rating factor as ultimately is shown on the worksheet project summary on worksheet 1 110.

Also a risk level is calculated based on the possible 10% and 20% over-run scenarios. The final calculated risk level is low, medium, or high depending on whether or not an overrun can take the project into a negative net benefit over the life of the project. If the net benefits never fall below zero, the risk is low, if they fall below zero for a 20% variance the risk is medium, and if they fall below zero at a 10% variance, the risk is high. This factor is not included in the final project rating and score, but is displayed on the worksheet 1 project summary page under Risk Level 117a as a separate factor that can be taken into account to compare projects.

Returning briefly to FIG. 2, 130 is the non-dollar benefits worksheet 3 130. Worksheet 3 130 allows the user to enter whether or not the project is a mandatory project and then to answer various weighted questions regarding non-dollar benefits of the project. The non-dollar benefit questions consider such areas as technology improvement and upgrades to alignment of the project in terms of furthering company visions and goals. The answers to the various questions are assigned numerical values within the model and the summed values of each weighted answer to the non-dollar questions are mapped to a total value for that section. Finally the section scores are combined and become the non-dollar score for the project. The mandatory project questions of block 132 serve only to advise the summary sheet as to whether the project must be accomplished, but otherwise in this embodiment, is not factored into the ROI calculations.

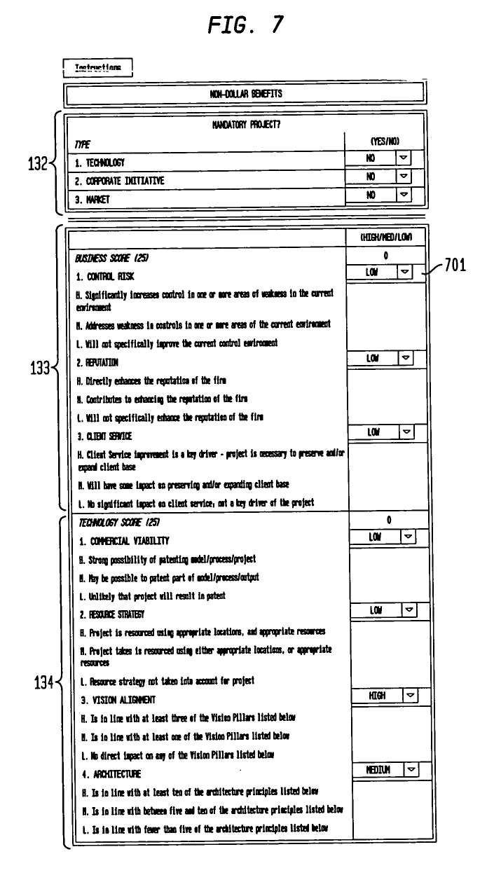

FIG. 7 shows a screen print of the non-dollar benefits page prior to user data entry. Mandatory project section 132 sets a “flag”, in this exemplary embodiment, to alert the user that, while the inventive method can be used to optimize a project, the project must be completed. The FIG. 7 scored sections are the business score 133 section and the technology score 134 section. Each item is user ranked as high, medium, or low by pull down menus 701. The results are then weighted, combined in each section and then the section scores are combined to provide the final non-dollar score. In this embodiment the range of non-dollar scores is 1 to 50.

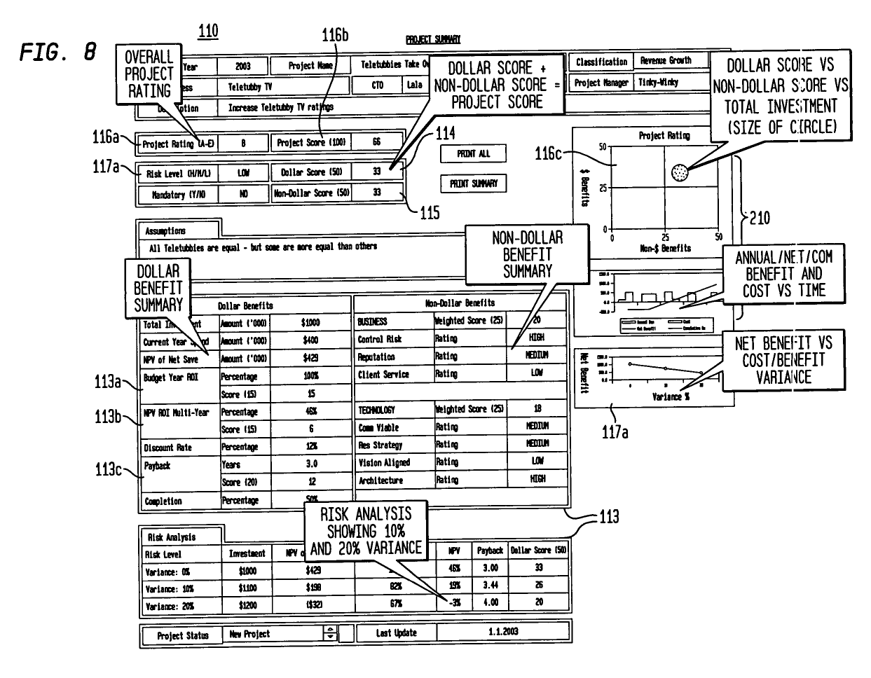

Once the worksheet user data entry fields have been populated to the extent the user desires to fill them out, the calculated results appear on a project summary worksheet. FIG. 8 shows an exemplary rated project on worksheet 110. Here, the dollar benefits have been calculated to have a net score of 33 as show in Dollar Score 114. This number was calculated from the three factors that make up the dollar benefit rating, the budget year ROI 113a is 15 (of the dollar score weight max 15 of 50), the multiyear NPV 113b is 6 (of the dollar score weight max 15 of 50) and the payback 113c is 12 (of the dollar score weight max 20 of 50).

On the non-dollar benefit side of the analysis of this project, the business section received a score of 15 (of the non-dollar score weight max 25 of 50), and a technology score of 18 (of the non-dollar score weight max 25 of 50) for a total non-dollar score 115 of 33. The dollar score 114 of 33 is added to the non-dollar score 115 of 33 for a project score 116b of 66. The project score 116b of 66 then maps to a standard project rating 116a of “B”.

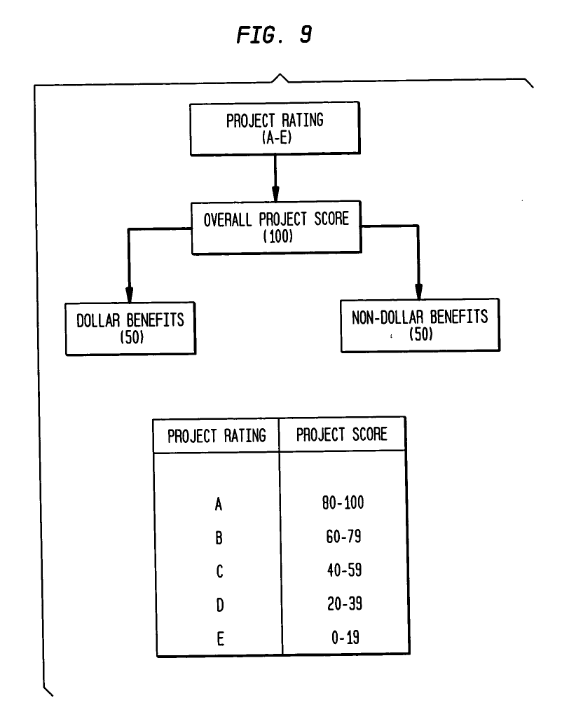

One inventive aspect of the method of measuring project viability is that all projects judged by this method can be easily compared with each other by ranking projects according to their project rating letter code. FIG. 9 defines the mapping of project rating to project score for this embodiment of the inventive method, as described above.

Another important aspect of the method is the graphical presentation of the plotted initial investment on dimensional scales of dollar benefits and non-dollar benefits, as shown in block 116c. Here the total investment of $1,000 K ($1 M) sets the diameter of the circle. The circle is then drawn on the plot at the corresponding values of dollar and non-dollar benefits. It can be seen that as that the circle becomes smaller (smaller diameter), it represents a smaller total investment, and as the circle becomes larger, there is a larger total investment. Similarly, as the circle's position moves to the upper right corner, the best projects are realized because both the dollar and non-dollar benefits scores are relatively high. A small diameter circle in the upper right hand quadrant represents the best projects with the highest benefits and lowest total cost. Thus, in addition to the letter project rating score 116a, a mere glance at the plots 210 for various projects allows one to quickly compare the viability of various competing projects.

The graphical display of plot 116c gives far more project detail expanded over the lifetime of a project and broken down by years. Here a 5 year period is displayed. The plot shows by bar graphs, the annual benefits (and thus a graphical representation of the value that contributes to the Budget year ROI value 113a), the cost of the project per year, and line graphs showing the net project benefit, and the cumulative project benefit.

Plot 117a shows the effects of various calculated cost over-runs. Here the effects of a 10% and a 20% cost over-run are shown. These values are as calculated and presented in the risk analysis area of section 113 to calculate the project risk level 117a. As the risk plot approaches zero on the y axis, the risk of the project (it's vulnerability to cost over-run) increases. When the line crosses zero, there is a potential for net project loss and the project risk rating falls to a high risk.

It can be seen that for relatively few user inputs either during pre-project planning or during the course of a working project, a comprehensive set of standard ROI ratings and graphs can be quickly generated. An important advantage of this method is efficiency of use. It is very easy to learn how to use the method and models generated by the method. The simplicity of the user inputs means that this exemplary embodiment of this invention may be used very quickly, and it is very easy to amend or update the input data. Most importantly, the method is flexible in that it is equally suitable to large and small projects.

The output offers an array of presentations so that functional results can be read quickly in summary form or in full detail. The presentations are intuitively understood and because of the standardization of project criterion and ratings, results can easily and seamlessly be used across a variety of LOBs. Furthermore, in the spreadsheet embodiment, resultant values are easily mapped into other spreadsheet for “drill down” comparisons; that is, there is a virtual “3D” aligning of resultant worksheet pages and spreadsheet functions may call an array of results from various projects.

Another useful aspect of the invention is that it can be used to analyze the feasibility of a project from either a “profit and loss” (P&L) or a “cash flow” viewpoint. Here the data is entered in such a way as to yield the desired project view. For example, cash flow view is particularly useful for high level project management because it gives the actual values of cash flowing in a given year. It is theoretically correct in terms of giving correct NPV data broken down annually, including breakdowns for capitalization. The user enters expenditures broken down in terms of annual spending.

In contrast, the P&L view according to this exemplary embodiment shows the total expenses lumped as single expenditures. Here, the object is to characterize the net overall project amounts. The P&L view is particularly useful to user groups proposing, comparing, and evaluating competing projects by comparing total costs. This view, showing less detail and annual breakdown is simpler and easier to view. Thus, the profit and loss view is particularly advantageous for project planning, including baseline cost, capitalization, and depreciation.

Other differences between the cash flow and profit and loss views include the way in which manpower is accounted for. Manpower related expenses can be entered into CID as “fully loaded costs” or “incremental costs”. This is the standard rate representing the cost of the employee (fully loaded), or the employee's detailed costs to the project (incremental) broken down by type and budget year including, salary and direct overhead costs, such as benefits, and non-cash costs as equipment and software used by that employee broken down by years of the project. Typically the fully loaded standard rates per person are used for the simpler P&L view, while annual incremental costs are used to generate the more complex cash flow view.

Once the inventive method according to this exemplary embodiment has been applied to a project, the results can be advantageously saved to a database. Database reports generated from the results database can be particularly useful for comparing projects to each other based on parameters such as the project rating. In comparing projects, the method's reports can be sorted by the names of responsible parties, budget years, or any other data field representing parameters from the method's functional results.

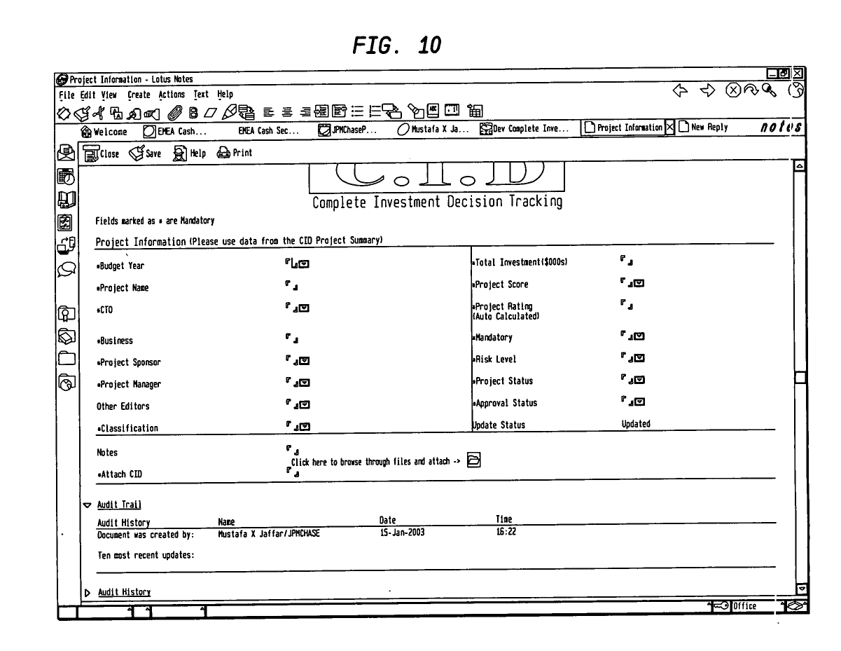

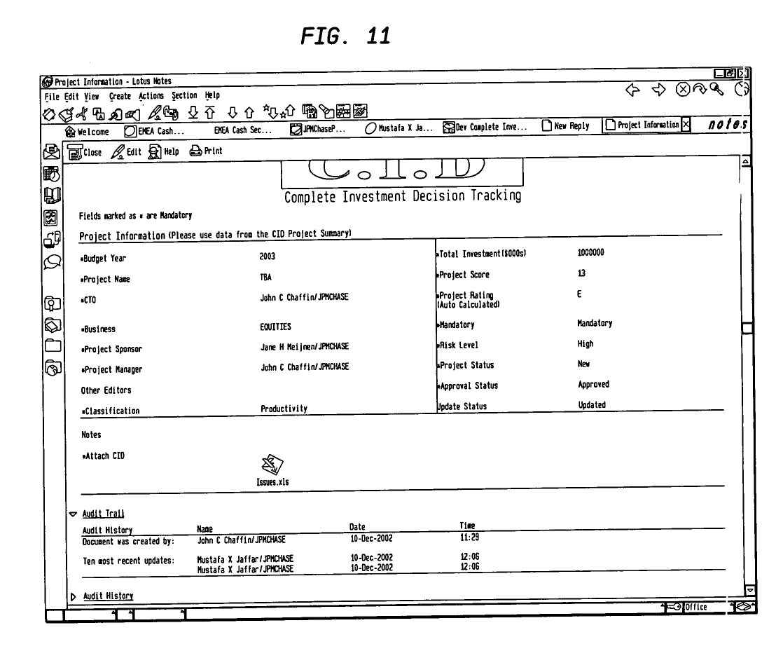

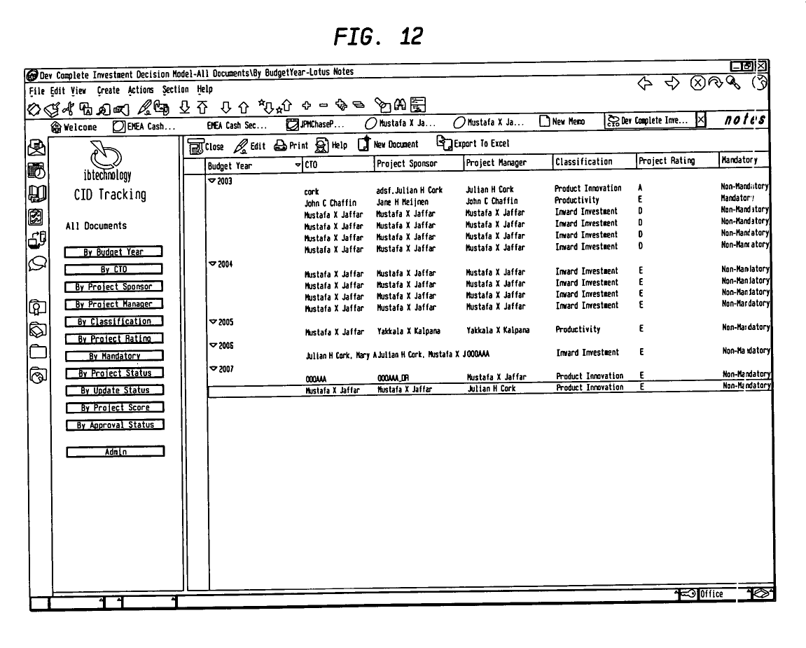

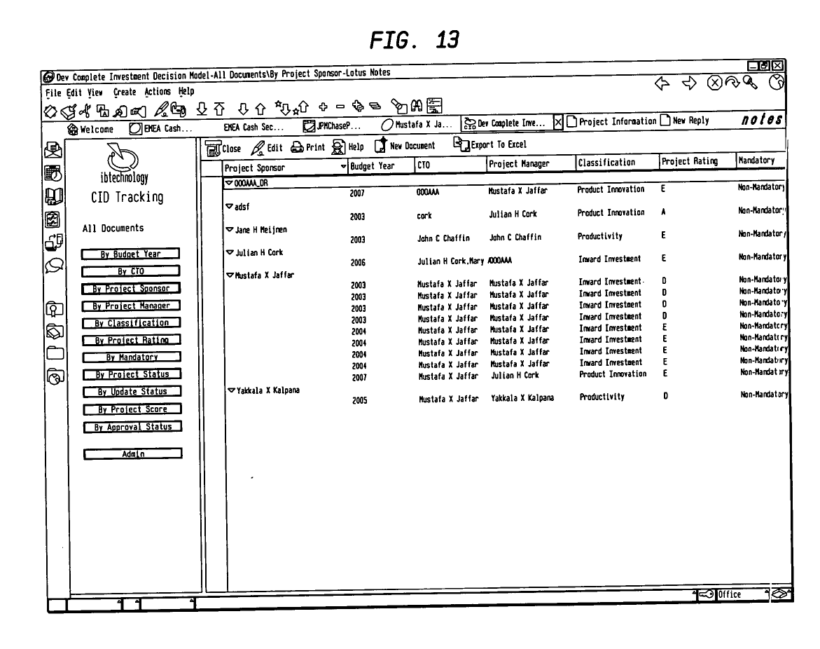

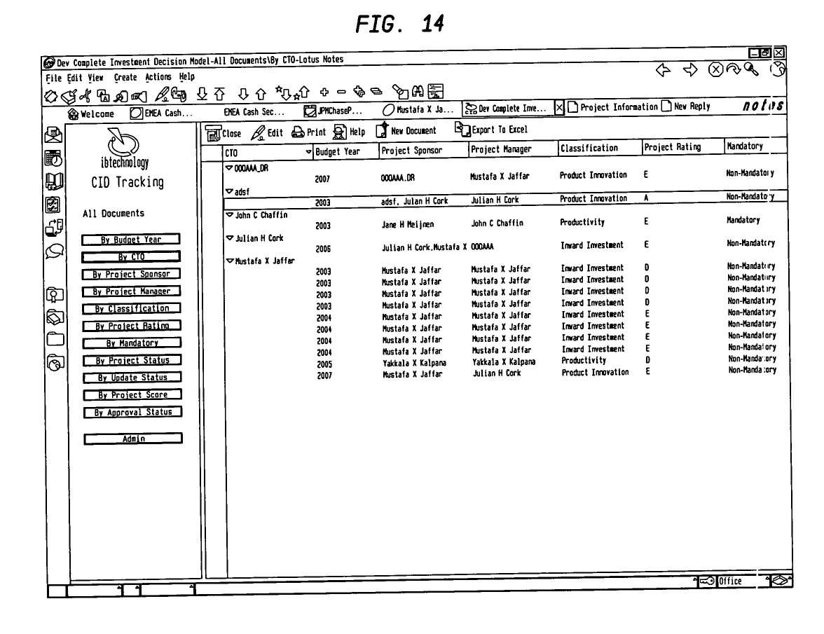

In one exemplary embodiment, the functional results of a spreadsheet program performing the method are stored in a LOTUS Notes (“LN”) database for convenient access by a corporation's email users. FIG. 10 shows a screen print of an exemplary LN entry form for recording the results to the database. While the illustration shows manual entry, it is possible to automatically map method output data into a database entry form. FIG. 11 shows a screen print of a completed entry form. In this specific embodiment, the method was completed as an Excel spreadsheet and attached as such to the database. FIG. 12 shows screen print of the project evaluation method's functional results sorted by budget year, FIG. 13 by project sponsor, and FIG. 14 by CTO. Other fields may serve as key sorting fields.

In the preferred embodiment, the inventive method is performed in a computer spreadsheet. The spreadsheet can reside on a server on a network and be downloaded to and run on a client terminal. The functional results of the method from the spreadsheet can then be uploaded to a database on the same or other server for convenient access and project comparisons. Alternatively, the method can be performed entirely within a web based application by a client terminal using, for example, an internet browser. In this latter exemplary embodiment, the program which performs the method can reside on the server as can the database to accept the functional results of the project analysis. The network on which the program, spreadsheet, or other computer code to execute the inventive method reside, can include the internet, be wholly self contained as an intranet, or reside entirely on one computer.

Part II: a Hypothetical Example of Project Planning Using the Standardized Project Rating and Graphical Summary

In this exemplary project, two computing systems are to be merged into one. The goal is to eliminate redundant computing facilities. The computing systems are both used for trading financial instruments on the international financial markets. The project has commenced. The savings to be made by the project are partially realized by the number of trades made on the system; however, due to a recent decline in the international financial markets, the volume of trading is down from 50,000 trades per day to 30,000 trades per day. Adding to the project's troubles, costs have gone up 50% due to an increase in consultants' fees and building rents. The project must be reviewed for viability. Savings need to be found by adjusting the input variables until a satisfactory corporate solution can be found.

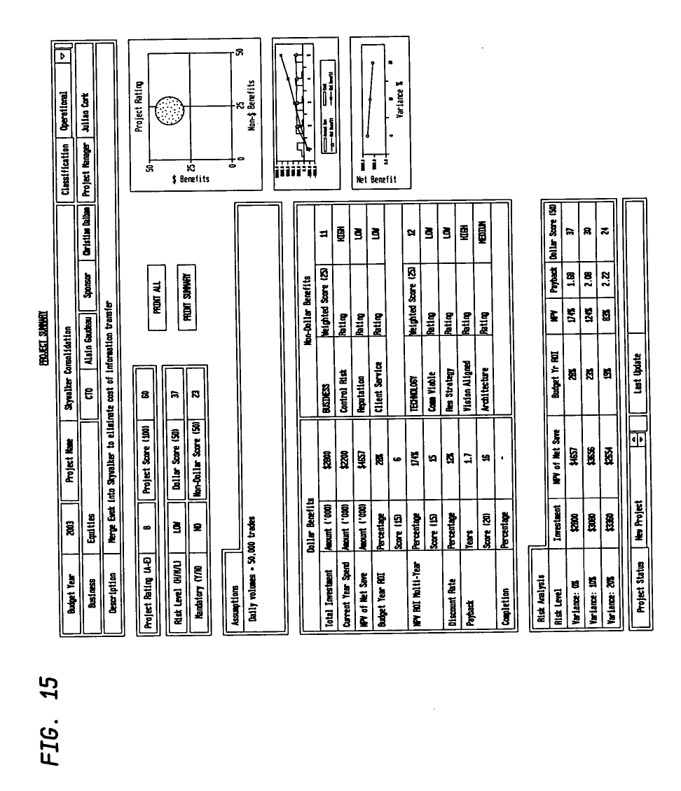

FIG. 15 shows the situation at 50,000 trades per day before the number of trades fell off. The project is rated a “B”, the project score is 60. The dollar score is 37 (calculated from the NPV net save divided by the investment to give an NPV ROI Multi-Year 174% scored at 15 of 15, the project will pay back in 1.7 years scored at 16 out of 20, and the budget year ROI at 28% returned of 2.2 $M scored at 6 out of 15). The non-dollar score is 23. The risk is rated as “low”. That is, if there is a 20% over-run, the project will not lose money.

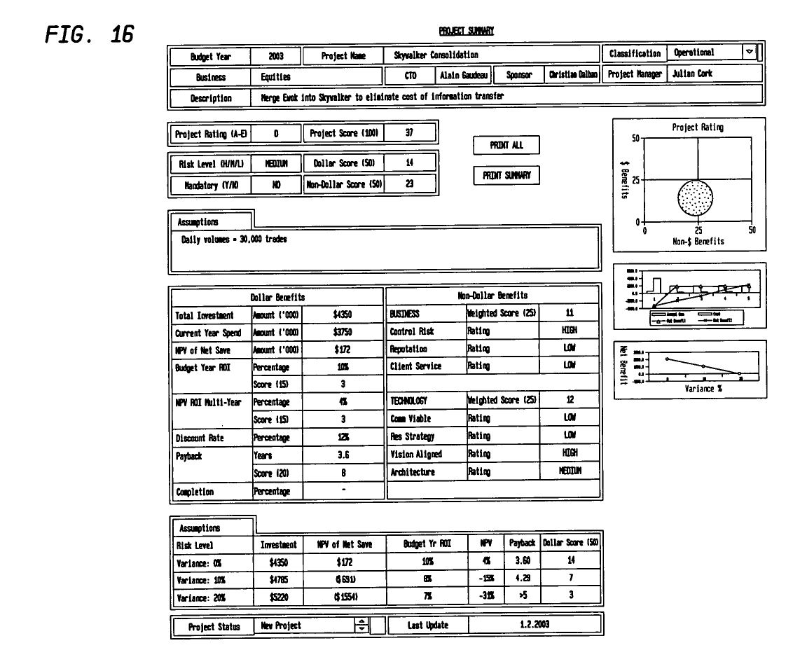

But now the project is near collapse and may have to be scrapped. FIG. 16 shows the situation after the number of trades fell to 30,000 trades per day. Project costs including consultant's fees and rents have also gone up by 50%. The project rating has fallen to “D” and the project score is now 37. The dollar score has fallen to 14 and the non-dollar score remains 23. The risk has risen to “medium”. A quick glance at the graphical presentation of the project rating shows that the circle 1500 has grown significantly in diameter. It has also dramatically fallen in dollar benefits.

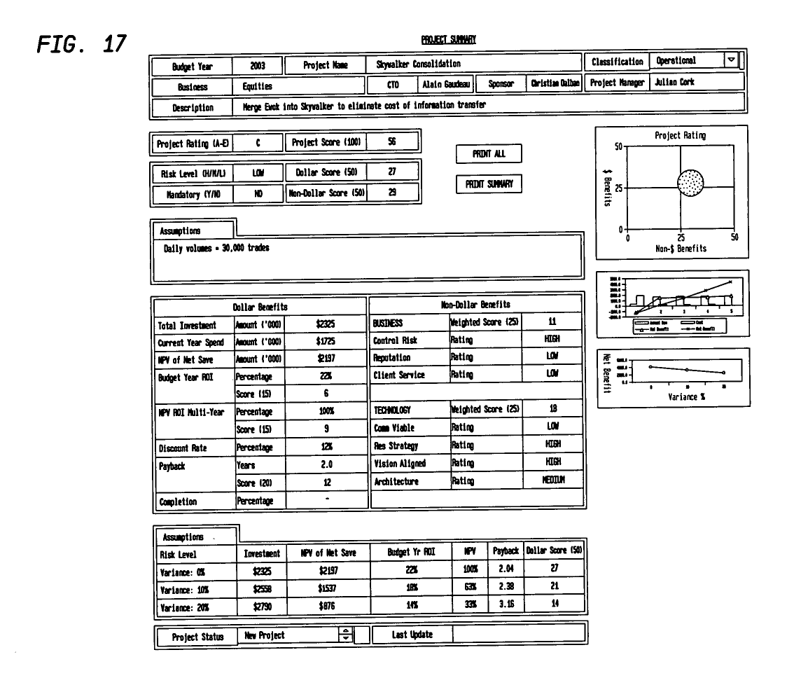

FIG. 17 shows the situation after the number of trades fell off but after some of the input parameters have been adjusted in an attempt to save the project. The corporation has made several changes in resource strategy. They have changed consulting firms to an alternative firm located in a far lower cost rural area. Both consultant's fees and building rents have fallen. The project rating has recovered to C, and the project score is up to 56. The dollar score has risen to 27 and the non-dollar score rises to 29. But, the risk is rated as “low”. The project now will likely not lose money and is once again viable.

In conclusion, a standardized method of evaluating projects can be useful to compare proposed projects and for making decisions on which projects should go ahead, or not, based on potential viability and net worth to the decision making parties. This standardized approach of the inventive method allows comparisons of disproportionate projects, such as between relatively small projects to very large ones. It also enhances the ability to compare projects even across disparate lines of business. And, the example has shown how ongoing projects can be reviewed and evaluated even after a project is in progress by using project summary, valuable tool to review and maintain the viability of ongoing projects.

We claim:

1. A computer assisted method for rating a project comprising the steps of:
receiving data describing the project;
generating a standardized rating of the project's viability by computing a plurality of project parameters based on the data including a computed dollar benefit score and a computed non-dollar benefit score;
plotting a symbol on a computer generated graph, wherein the area of the symbol is proportional to a project parameter, and wherein the symbol is plotted on a graph having at least a first coordinate axis representing the computed dollar benefit score and the second coordinate axis representing a computed non-dollar benefit score; and
taking an action based on the graph.

2. The method of claim 1 wherein receiving data comprises receiving data by inputting data into a spreadsheet.

3. The method of claim 1 wherein receiving data comprises receiving data into a spreadsheet program selected from the group consisting of Excel, Lotus 1-2-3, Quattro, and Quattro-Pro.

4. The method of claim 1 wherein plotting a symbol on a graph comprises plotting a circular symbol on a graph.

5. The method of claim 4 wherein plotting a symbol on a graph comprises plotting a circular symbol of variable area on a graph.

6. The method of claim 4 wherein plotting a symbol on a graph comprises plotting a circular symbol of variable area on a graph, wherein the area is proportional to a total project cost.

7. The method of claim 5 wherein plotting on a graph comprises plotting on a graph in the Cartesian coordinate system.

8. The method of claim 1 wherein taking an action based on the project's graph comprises taking an action selected from the group consisting of modifying the project, canceling the project, postponing the project, and making no changes to the project.

9. A System to generate standard ratings of projects comprising:
a computer for receiving data about a project;
the computer programmed to assign a dollar, and a non-dollar value, and a project score to each project, and further programmed to display a graph including a symbol plotted on a graph, the graph having at least two axis including a first axis, and a second axis, the first axis representing the dollar value and the second axis representing the non-dollar score for each project and the area of the symbol representing the cost of the project.

10. The system of claim 9 wherein the computer comprises a client computer and a server computer connected by a network.

11. The system of claim 9 wherein the programmed computer is programmed on a spreadsheet program.

12. The system of claim 11 wherein the programmed computer is programmed in Excel.

13. The system of claim 11 wherein the programmed computer is programmed in a computer language.

14. The system of claim 13 wherein the programmed computer is programmed in an object oriented computer language.

15. The system of claim 14 wherein the programmed computer is programmed in an object oriented computer language selected from the group comprising C++, Java, and J2EE.
